(19) United States
(12) Patent Application Publication
(10) Pub. No.: US 2025/0191497 A1
(43) Pub. Date: Jun. 12, 2025

(54) ENDOSCOPIC ENDONASAL SKULL BASE SURGERY TRAINER

(71) Applicants: ALL INDIA INSTITUTE OF MEDICAL SCIENCES (AIIMS), New Delhi (IN); DBT- DEPARTMENT OF BIOTECHNOLOGY, GOVT. OF INDIA, New Delhi (IN)

(72) Inventors: Ramandeep SINGH, New Delhi (IN); Rajdeep SINGH, New Delhi (IN); Ashish SURI, New Delhi (IN)

(21) Appl. No.: 18/845,318

(22) PCT Filed: Mar. 8, 2023
(86) PCT No.: PCT/IB2023/052194

§ 371 Date: Sep. 9, 2024

(30) Foreign Application Priority Data
Mar. 9, 2022 (IN) 202211012682

(51) Int. Cl. G09B 23/28

(52) U.S. Cl. CPC G09B 23/285

(57) ABSTRACT

Disclosed herein a neurosurgical simulator for training of various tasks involved in Endoscopic Endonasal Transsphenoidal Surgery, composed of a human head model comprising an anterior portion including a nose part, and a posterior portion detachably mounted on an inclined base part; a plurality of apertures on the nose part for insertion of an endoscope and an instrument for manipulation; said inclined base part placed at an inclination to mimic a patient position during endo-nasal surgery; wherein said base part comprises a protruded platform having slots to create male-female connection with corresponding a plurality of protrusions provided under one or more activity plates; wherein said activity plates are so designed to train various tasks including pick-place, drilling, incising, punching/grasping and precision movements around the anatomical structures. The simulator further comprises sensors including touch sensors, force sensors and accelerometers configured to track the performance of the user and provide feedback. The simulator further comprises a pair of articulated arms with encoders at each joint of said arm connected to the endoscope and the instrument for tracking the kinematic data of the user.

### TECHNICAL FIELD

The present invention in general relates to a training apparatus; more particularly, a training apparatus or trainer or a neurosurgical simulator for various tasks involved in Endoscopic Endonasal Transsphenoidal Surgery procedure. The tasks identified for EETS surgery include pick-place, drilling, incising, punching/grasping and precision movements around the anatomical structures.

### BACKGROUND OF THE INVENTION

The endo-nasal transsphenoidal approach is the least traumatic nasal route to the sella turcica and extended skull base, avoids the need for brain retraction, and also offers improved visualization of the surgical field. When compared with transcranial procedures, this approach results in lower morbidity and mortality rates. However, Endoscopic Endonasal Transsphenoidal Surgery (EETS) surgery is a complex procedure that requires meticulous focus and technical expertise. Traditional apprenticeship-based training does not provide the trainee with hands-on technical skills and hence is not applicable for training of MIS procedures. Also, residency duty-hour restrictions have resulted in reduced exposure of trainees to surgical cases. These two factors have led to rapid increase in the interest of simulation-based training models for neurosurgery. Neuroendoscopy demands independent visual, bi-manual psychomotor skills. Narrow, monocular field of view and video presentation on the 2-Dimensional (2D) display limits the visual feedback. The monoscopic view leads to missing depth cues, and a narrow field of view leads to difficulty in forming a 3-dimensional (3D) mental picture. The endoscope is moved forward and backward to obtain the depth cue. The reflection of the light on different surfaces helps in identifying the distance. Tactile and haptic feedback is limited due to the use of long instruments, the fulcrum effect and a reduced degree of freedom. The long instruments and endoscope are inserted by creating an opening in the skull or through natural orifices. The endoscope has four degrees of freedom (DOF) constrained by the fulcrum at the entry site, and an additional DOF for the relative rotation of the camera along its axis. The skills required in neuroendoscopy are thus challenging and requires dedicated training systems and deliberate practice. Simulation based training is still in infancy stage and most of the surgical training labs lack patient specific simulators.

Most of the currently available surgical simulators are related to laparoscopy and there is limited development of neurosurgical simulators. The simulators that have been developed for neurosurgery are not patient specific, do not cover all tasks and lack evaluation metrics.

Reference made to US patent document US20050181340A1. This invention discloses an adaptive simulation environment particularly suited to laparoscopic surgical procedures. A computer-based learning environment automatically increases (or decreases) difficulty in tasks without discrete levels based on performance, thereby maintaining users in an optimal learning “zone,” while accommodating varying levels of skill without frustration or boredom. The method includes the steps of specifying a task to be performed in conjunction with an object; displaying the object in the environment for a predetermined period of time; and modifying the display as a function of the user's ability to complete the task in the predetermined period of time.

Further reference is made to RU180078U1. This invention discloses a simulator for skill development in endonasal endoscopic surgery. The utility model relates to medical equipment, namely, teaching aids in otorhinolaryngology, and is intended for the development and improvement of manual skills of working with medical instruments under the control of the endoscopic system, which are necessary to perform basic surgical techniques of endonasal endoscopic surgery. Improving the quality of training by expanding the area of manipulation with a medical instrument is achieved by the fact that in the simulator for mastering manual skills in endonasal endoscopic surgery, containing a tripod, on which a model of the nasal cavity is mounted, made in the form of a removable cylinder with the possibility of changing its position in space, with an internal part of the model of the nasal cavity is configured to insert an endoscope and an instrument for endonasal endoscopic surgery into it, and also contains inside it the exchange element simulating the structure of the nasal cavity, the replaceable element is made in the form of an insert that is destroyed as a result of exposure to it with an endonasal endoscopic surgery instrument, and the model of the nasal cavity is made in the form of a truncated cylinder, the beveled end of which is located on the input side of the endoscope and instrument for endonasal endoscopic surgery, and the longest generatrix of which is located above its axis.

Yet another reference is made to RU190669U1. It relates to simulator for the development of manual surgical skills on the brain department of the head in real topograph-anatomical medium. The utility model relates to the field of medicine, namely, neurosurgery and operative surgery, and can be used to develop the correct manual surgical skills for students in the brain region of the head when performing the craniotomy steps, namely, incision of the skin, imposing cutter holes, cutting out a bone graft, opening a solid the dura mater and layer-by-layer stitching of tissues with bone grafting, and an objective assessment of trepanation performed.

Reference is made to US 20180114466. In this document, a training apparatus for endoscopic endonasal skull base surgery, composed of a human head model and liquid circulation means has been disclosed. The human head model comprises an anterior portion including a nose part in which nostrils are formed, and a main portion including at least part of a nasal septum, at least part of a nasal cavity lateral wall, at least part of a sphenoidal sinus posterior wall, and at least part of an internal carotid artery; and the liquid circulation means comprises a storage tank for storing a nontransparent colored liquid, a supply flow path disposed between the storage tank and the at least part of the internal carotid artery, a return flow path disposed between the at least part of the internal carotid artery and the storage tank, and a circulation pump for circulating the liquid within the storage tank through the supply flow path, the at least part of the internal carotid artery, and the return flow path. However, it does not provide training of EETS surgery tasks and does not disclose the use of activity plates or platforms nor does it disclose the use of sensors or AI techniques.

Yet another reference is made to U.S. Pat. No. 10,902,745B2. This document refers to an electro-mechanical box trainer for neurosurgery comprising: (i) a base part which comprises a rubberized working port for insertion of endoscope and tool for manipulation, a microcontroller programmed motorized peg plate placed at 45° degrees of inclination for defining a practice volume according to the neuroendoscopy, a membrane keypad to change the angle of rotation of said peg plate along vertical axis, liquid crystal display (LED) array to illuminate the interior of the box and a removable base plate to house the circuitry; and (ii) a removable part enclosed of five walls such as a front wall, two lateral walls, a back wall and a top wall, comprises a housing to mount an auxiliary camera to record all the task for evaluation and a slider at the back to adjust the camera focus. The document further reveals insertion of the endoscope and tool through the working port provides access to an activity area to perform pick and place task by manipulating the rubber rings placed on the peg. However, the invention is a box trainer and does not include patients CT data based head model.

Further reference is made to U.S. Pat. No. 10,319,259B2. It relates to anatomical simulators produced using 3D printing. Disclosed herein are anatomical simulators produced using three-dimensional (3D) printing to produce interior components of the simulator. The method of producing void structures in an anatomical phantom, includes 3D printing one or more structures of one or more desired sub-anatomical features using a dissolvable material; supporting and enclosing the one or more structures in an interior of a mold of the anatomical phantom; filling a remaining internal volume in the interior of the mold between an outer surface of the one or more structures and an inner surface of the mold with a liquid precursor of a matrix material selected to mimic anatomical tissue and processing the liquid precursor to form a tissue mimic matrix material; and dissolving the one or more structures with a fluid selected to dissolve said dissolvable material to produce internal cavities within the tissue mimic matrix material.

Further reference is made to non-patent literature “Geometric and mechanical evaluation of 3D-printing materials for skull base anatomical education and endoscopic surgery simulation—A first step to create reliable customized simulators”; authored by Favier et.al. DOI: 10.1371/journal.pone.0189486; Dec. 18, 2017. This document aims to evaluate several consumer-grade materials to create a patient-specific 3D-printed skull base model for anatomical learning and surgical training. Four 3D-printed consumer-grade materials were compared to human cadaver bone; calcium sulfate hemihydrate (named Multicolor), polyamide, resin and polycarbonate. The geometric accuracy, forces required to break thin walls of materials and forces required during drilling were compared. The authors of this article opine that Polycarbonate is a good substitute of human cadaver bone for skull base surgery simulation. Thanks to short lead times and reasonable production costs, patient-specific 3D printed models can be used in clinical practice for pre-operative training, improving patient safety. However, there is no suggestion in this document related to CT based scalp model and activity plates for the training of pick-place, drilling, incising and precise movement tasks in endoscopic endo-nasal skull base surgery. Further, this article does not include any mechanism to measure the kinematics of surgeon's activity.

Therefore, there remain a need for a neurosurgical simulator for training of various tasks involved in Endoscopic Endonasal Transsphenoidal Surgery procedure like pick-place, drilling, incising, punching/grasping and precision movements around the anatomical structures.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

An object of the present disclosure is to provide a neurosurgical simulator for training of various tasks involved in Endoscopic Endonasal Transsphenoidal Surgery procedure like pick-place, drilling, incising, punching/grasping and precision movements around the anatomical structures.

Another object of the present invention is to develop and improve manual skills with neuro-endoscopic instruments for endo-nasal approach.

Yet another object of present invention is to allow development of fundamental neuro-endoscopic skills in safe and controlled environment in surgical training labs.

Further object of present invention is to develop psychomotor skills and learn usage of various neuro-endoscopic instruments.

One aspect of present invention is to provide a neurosurgical simulator for training of various tasks involved in Endoscopic Endonasal Transsphenoidal Surgery (EETS) procedure. It is composed of a human head model comprising an anterior portion including a nose part, and a posterior portion detachably mounted on an inclined base part; a plurality of apertures on the nose part for insertion of an endoscope and an instrument for manipulation; said inclined base part placed at an inclination to mimic a patient position during endo-nasal surgery; wherein said base part comprises a protruded platform having slots to create male-female connection with corresponding a plurality of protrusions provided under one or more activity plates; wherein said activity plates are so designed to train various tasks including pick-place, drilling, incising, punching/grasping and precision movements around the anatomical structures. The EETS simulator has been designed using CT scan data of adult patient to provide environment similar to endo-nasal approach, whereas most of the prior art relates to box-based simulator.

The nasal portion has been fabricated in an elastic material and housing with rigid plastic using multi-material 3D printing. The activity plates have been developed by observing the operative videos, CT scan images and feedback of expert neurosurgeons for tasks including pick-place, drilling, incising and precision movements. The activity plates have been fabricated with materials mimicking bio-mechanical properties of real tissues. Various sensors including touch sensors, force sensors and accelerometers have been placed in the simulator or on the instruments to track the performance of the surgeons and provide feedback. A pair of articulated arms with encoders at each joint have been designed with the base part of the simulator to collect kinematic data of the trainee surgeons. The collected data from all the sensors is analyzed using AI-Artificial Intelligence techniques including machine learning and deep learning.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF ACCOMPANYING DRAWINGS

The above and other aspects, features and advantages of the embodiments of the present disclosure will be more apparent in the following description taken in conjunction with the accompanying drawings, in which:

FIG. 1 illustrates the complete setup of EETS simulator with involved instruments and articulated arms for kinematic data recording.

FIG. 2 illustrates a block diagram depicting the workflow of EETS simulator and skills evaluation.

FIG. 3 illustrates a schematic diagram depicting the exploded view of the EETS simulator.

FIG. 4 illustrates a schematic diagram depicting the anterior and posterior portions without the nose part of the simulator.

FIG. 5 illustrates a schematic diagram depicting the flexible nose part of the EETS simulator.

FIG. 6 illustrates a schematic diagram the base part of the EETS simulator that has provision for fixation of the posterior portion of the human head model and activity plates.

FIG. 7 illustrates a schematic diagram depicting the pick-place activity plate.

FIG. 8 illustrates a schematic diagram depicting the internal precision movement activity plate.

FIG. 9 illustrates a schematic diagram depicting the outer precision movement activity plate.

FIG. 10 illustrates a schematic diagram depicting the incising activity plate.

FIG. 11 illustrates a schematic diagram depicting the drilling activity plate.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary implementations of the invention. It includes various specific details to assist in that understanding but these are to be regarded as merely exemplary.

Features that are described and/or illustrated with respect to one implementation may be used in the same way or in a similar way in one or more other implementations and/or in combination with or instead of the features of the other implementations.

The various embodiments of the present invention describe an Endoscopic Endonasal Skull Base Surgery Trainer/Simulator. The various embodiments herein may include one or more of the components to provide Endoscopic Endonasal Transsphenoidal Surgery (EETS) Simulator. In the following description, for purpose of explanation, specific details are set forth in order to provide an understanding of the present disclosure.

The present invention relates to a neurosurgical simulator for training of various tasks involved in Endoscopic Endonasal Transsphenoidal Surgery, composed of a human head model comprising an anterior portion including a nose part, and a posterior portion detachably mounted on an inclined base part; a plurality of apertures on the nose part for insertion of an endoscope and an instrument for manipulation; said inclined base part placed at an inclination to mimic a patient position during endo-nasal surgery; wherein said base part comprises a protruded platform having slots to create male-female connection with corresponding a plurality of protrusions provided under one or more activity plates; wherein said activity plates are so designed to train various tasks including pick-place, drilling, incising, punching/grasping and precision movements around the anatomical structures.

According to one embodiment of present invention, said base part is inclined at 45° angle.

In one of the embodiments, the present invention is related to EETS simulator the outer body of which has been developed by using CT scan data of the head. The surface model of outer body has been developed by segmentation of the region of interest related to Endoscopic Endonasal Transsphenoidal Surgery.

In another embodiment, the 3D solid model of the outer body has been developed by reverse engineering of the surface model developed by CT image segmentation and physical model using 3D printing techniques.

In another embodiment, the nasal part has been developed in soft polymeric material and rest of the simulator body has been developed in hard plastic material.

In a preferred embodiment, said soft polymeric material is selected from Agilus and Silicone materials and combinations thereof. In a preferred embodiment, said hard polymeric material is Acrylonitrile Butadiene Styrene (ABS) plastic.

In another embodiment, the activity plates are fabricated with materials such as Bone matrix, Agilus and Silicone mimicking bio-mechanical properties of real tissues.

In another embodiment, the various activity plates related to pick-place, drilling, incising, punching/grasping and precision movements tasks have been developed.

In another embodiment, a base part has been developed for fixation of the simulator body and insertion of various activity plates. The angle of the base has been kept as per patient position as in during endo-nasal surgery. In a preferred embodiment, said base part is inclined at 45° angle.

In yet another embodiment, various sensors have been arranged inside the simulator and on the instruments that tracks the surgeon's activity and provide feedback in case of erroneous movement. These sensors may include touch sensors, force sensors and accelerometers as per the surgical task.

In yet another embodiment, a pair of articulated arms have been attached to the simulator that connects to the endoscope and instrument for tracking the kinematic data of the trainee surgeon.

In yet another embodiment, Artificial Intelligence techniques including machine learning and deep learning techniques are used for the analysis and scoring of the surgeon's skills as per the proficiency level.

According to one embodiment of present invention, FIG. 1 includes the complete setup of the EETS simulator, wherein EETS simulator assembly 1, simulator head model 2, inclined base plate assembly 3, articulated arms for kinematic data recording 4, attachment for articulated arm with base plate assembly 5, and endoscope 6, biopsy instrument 7, and encoders 8 are illustrated.

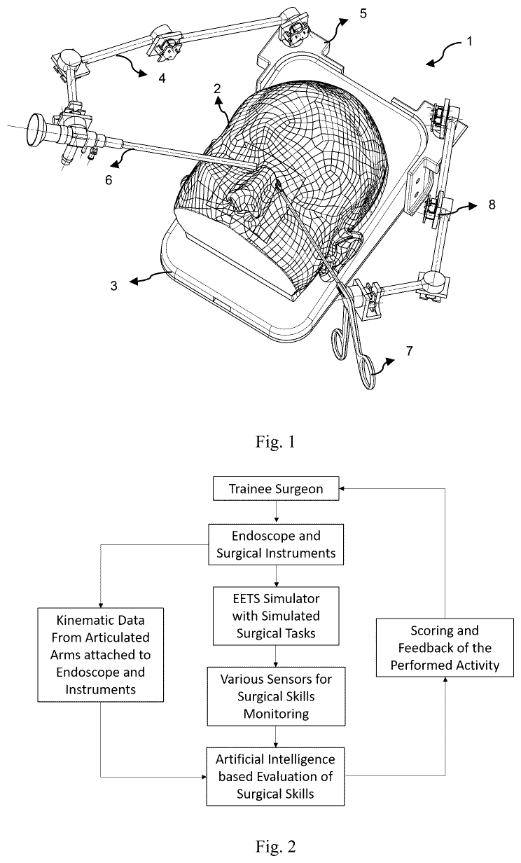

FIG. 2 includes a block diagram depicting the workflow of EETS simulator training methodology and artificial intelligence-based skills evaluation using kinematic or sensor data.

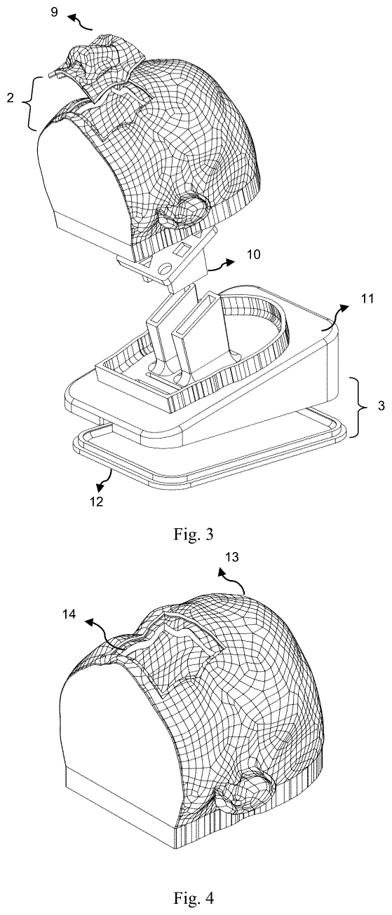

FIG. 3 illustrates a schematic diagram depicting the exploded view of the EETS simulator, wherein elastic nasal portion 9, simulator head model 2, activity plate mount 10, base plate upper portion 11 and base plate lower portion 12 are illustrated.

FIG. 4 illustrates a schematic diagram depicting the anterior 14 and posterior portion 13 without the nose part of the simulator.

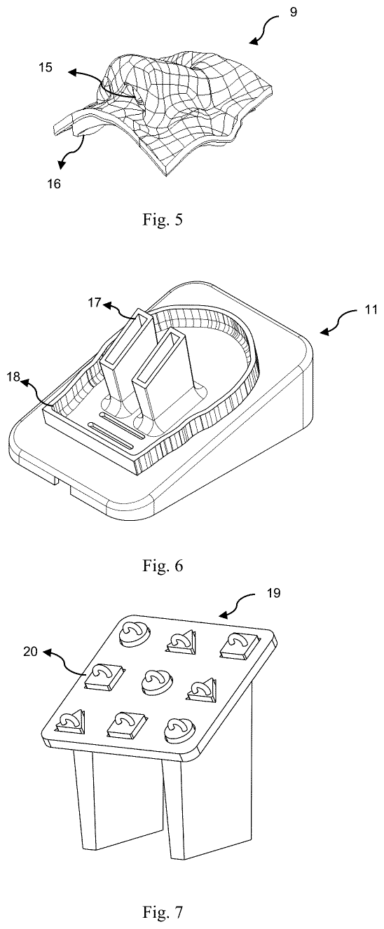

FIG. 5 illustrates a schematic diagram depicting the flexible nose part 9 of the EETS simulator with endoscope and instrument entry points 16 and provision for its attachment to head model 16.

FIG. 6 illustrates a schematic diagram of the base part of the EETS simulator that has provision for fixation of the posterior portion of the human head model 18 and activity plates 17.

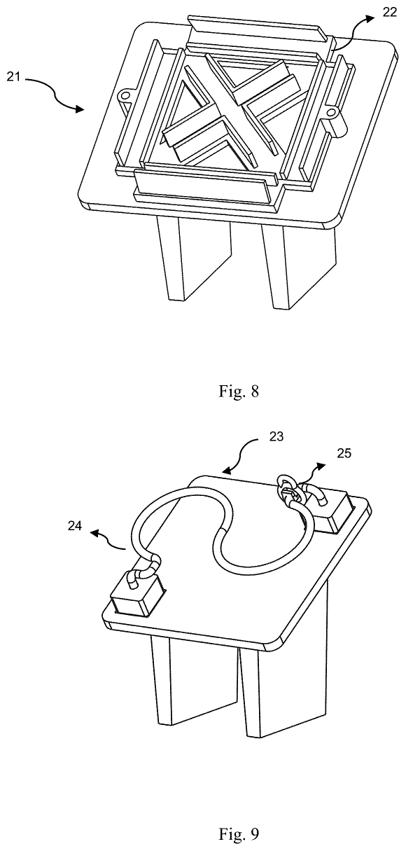

FIG. 7 illustrates a schematic diagram depicting the pick-place activity plate 19 and objects for pick-plate activity 20.

FIG. 8 illustrates a schematic diagram depicting the internal precision movement activity plate 21 and internal precision movement activity area 22.

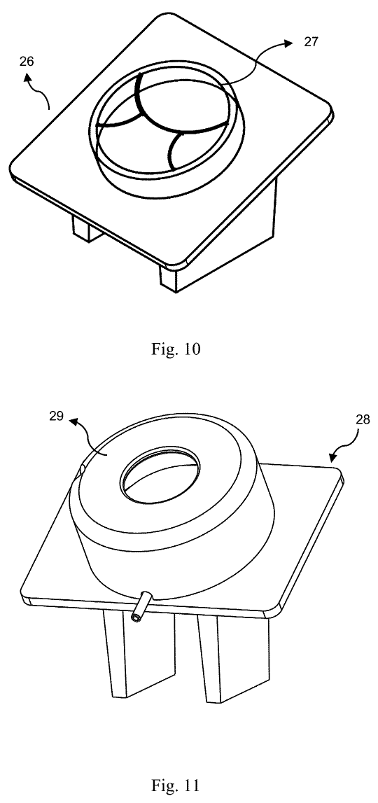

FIG. 9 illustrates a schematic diagram depicting the outer precision movement activity plate 23, outer precision movement activity path 24 and object 25 for movement along the path.

FIG. 10 illustrates a schematic diagram depicting the incising activity plate 26 with soft elastic material based incising area 27.

FIG. 11 illustrates a schematic diagram depicting the drilling activity plate 28 with the drilling activity area.

It will be apparent to those skilled in the art that various modifications and variations can be made in the present invention without departing from scope and spirit of the invention. It is intended that present invention covers such modifications and variations disclosed in the description.

1. A neurosurgical simulator for training of various tasks involved in Endoscopic Endonasal Transsphenoidal Surgery, composed of a human head model comprising an anterior portion including a nose part, and a posterior portion detachably mounted on an inclined base part; a plurality of apertures on the nose part for insertion of an endoscope and an instrument for manipulation; said inclined base part placed at an inclination to mimic a patient position during endo-nasal surgery; wherein said base part comprises a protruded platform having slots to create male-female connection with corresponding a plurality of protrusions provided under one or more activity plates; wherein said activity plates are so designed to train various tasks including pick-place, drilling, incising, punching/grasping and precision movements around the anatomical structures.

2. The neurosurgical simulator as claimed in claim 1, wherein said base part is inclined at 45° angle.

3. The neurosurgical simulator as claimed in claim 1, wherein said human head model is developed using CT scan data of adult patient to provide path similar to endo-nasal approach.

4. The neurosurgical simulator as claimed in claim 1, wherein the nose part is fabricated in soft polymeric material and said anterior and posterior parts are fabricated with hard polymeric material using multi-material 3D printing.

5. The neurosurgical simulator as claimed in claim 3, wherein said soft polymeric material is selected from Agilus, and Silicone materials and combinations thereof.

6. The neurosurgical simulator as claimed in claim 3, wherein said hard polymeric material is Acrylonitrile Butadiene Styrene (ABS) plastic.

7. The neurosurgical simulator as claimed in claim 1, wherein the activity plates are fabricated using 3D printing techniques with materials selected from Bone matrix, Agilus and Silicone mimicking bio-mechanical properties of real tissues.

8. The neurosurgical simulator as claimed in claim 1, further comprising sensors including touch sensors, force sensors and accelerometers configured to track the performance of the user and provide feedback.

9. The neurosurgical simulator as claimed in claim 1, further comprising a pair of articulated arms with encoders at each joint of said arm connected to the endoscope and the instrument for tracking the kinematic data of the user.

10. The neurosurgical simulator as claimed in claim 6, wherein the collected data from the sensors is analyzed using AI-Artificial Intelligence techniques including machine learning and deep learning.
